(19) United States
(12) Patent Application Publication
(10) Pub. No.: US 2003/0190927 A1
(43) Pub. Date: Oct. 9, 2003

(54) Modular communications device and associated methods

(76) Inventors: Raymond M. Leong, Los Altos, CA (US); Wei Yuan, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/112,785

(22) Filed: Mar. 28, 2002

(51) Int. Cl. H04B 7/00

(52) U.S. Cl. 455/525; 455/561; 455/15

(57) ABSTRACT

A modular communications device and associated methods are generally described herein. According to one aspect of the invention, a wireless communication device is presented comprising a processing module and a radio frequency interface module (RIM). In accordance with one embodiment of the teachings of the present invention, the RIM is removably coupled to the processing module, enabling the processing module to be used in multiple different spectra by simply coupling a RIM suitable for the desired wireless spectrum.

### TECHNICAL FIELD

The present invention generally relates to the field of wireless communication systems and, more particularly, to a modular communications device and associated methods.

### BACKGROUND

Conventional wireless communications devices, e.g., subscriber units, wireless modems, communication elements of a wireless networking system, wireless data processing terminals and the like are typically comprised of a single, integrated unit. An example of just such a conventional wireless communications device is presented with reference to FIG. 1.

Turning briefly to FIG. 1, a generic block diagram of a conventional wireless communications device is presented. As shown, the device is generally comprised of control logic 102, a digital signal processor 104, memory 106, an input/output (I/O) interface 108, a transmitter 110, a receiver 112, synthesizer(s) 114, amplifier elements 116 and 118, a duplexer/filter 120, and an antenna, each communicatively coupled as depicted. Those skilled in the art will appreciate that the control logic 102 and digital signal processor 104 generally control the communications device and process data at baseband in accordance with the modulation technique, multiple access method supported by the communications device 100. The transmitter 110 and receiver 112 in combination with the amplifier elements 116 and 118 and the duplexer/filter 120 process the signal to/from baseband, by downconverting/upconverting the signal from/to a suitable carrier frequency in accordance with the communications system for which the device 100 was designed.

A drawback to the integrated nature of such conventional wireless communication devices such as device 100 is that they are not readily adaptable to enable the end-user to use these devices in multiple different communication systems. That is, for any given multiple access wireless communication technology, e.g., time division multiple access (TDMA), code division multiple access (CDMA), frequency division multiple access (FDMA), spatial division multiple access (SDMA), etc. different countries or communication systems may well utilize different communication spectra of the wireless frequency spectrum. For example, analog wireless telephony systems exist in the United States (e.g., the advanced mobile phone system (AMPS) and its progeny) as well as Europe (e.g., the total access communication system (TACS) and its progeny). Whereas the baseband processing in such systems is substantially the same, certain aspects of the radio frequency (RF) communication environment, e.g., the channel spectrum, channel size, etc. is drastically different, inhibiting an AMPS subscriber unit from functioning within a TACS wireless system. Historically, such differences have required a user traveling between the two environments buy two, separate, communications devices, one for use in the US environment and another for use in the European environment.

Similarly, the communication spectrum employed by wireless data networks may well be different when traveling between different countries, regions within a country, or implementations within an office building. One example of a wireless data network, the wireless Ethernet, or so-called WI-FI systems, has enjoyed increasing popularity among corporate and residential clients alike. The flexibility of the wireless networking paradigm is ideal for use in accordance with a mobile computing device (e.g., laptop, personal digital assistant (PDA), etc.). One of the problems associated with such wireless networking systems, however, is that a user would have to purchase a separate wireless interface (colloquially referred to as an access point) for each of the radio frequency environments in which they may wish to engage in wireless networking—a costly proposition for such a convenience.

Recently, a modular portable data processing terminal was described in U.S. Pat. No. 6,014,705 issued to Koenck, et al. This patent generally describes a modular, portable data collection terminal with a removable transmitter element. The '705 patent describes a two-piece system where the base unit (akin to a computing device) has a processor and associated memory, while the second unit, the wireless interface, also requires a dedicated processor, associated memory, in addition to the RF upconversion and filtering (colloquially referred to herein as a “radio”) elements. In this regard, the Koenck system is akin to traditional notions of portable computing with a computing device coupled with an integrated wireless interface. The fact that Koenck's wireless interface requires a dedicated processor and associated memory greatly increases the cost associated with such a module and, in this regard, would retard its acceptance in a consumer market. Moreover, the fact that Koenck's wireless interface only provides uplink capability limits its appeal to other, e.g. two-way communication, applications.

### SUMMARY

A modular communications device and associated methods are generally described herein. According to one aspect of the invention, a wireless communication device is presented comprising a processing module and a radio frequency interface module (RIM). In accordance with one embodiment of the teachings of the present invention, the RIM is removably coupled to the processing module, enabling the processing module to be used in multiple different spectra by simply coupling a RIM suitable for the desired wireless spectrum.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 illustrates a block diagram of a conventional wireless communications device;

FIG. 2 is a block diagram of an example communications device incorporating the teachings of the present invention;

FIG. 3 is a flow chart of an example method for identifying an appropriate radio module to use in a communications environment;

FIG. 4 is a graphical illustration of a wireless communication device incorporating the teachings of the present invention, in accordance with one example implementation of the present invention;

FIG. 5 is a graphical illustration of a wireless communication device incorporating the teachings of the present invention, in accordance with another example implementation of the present invention;

FIG. 6 is a block diagram of an example wireless communication system in which the teachings of an example embodiment of the present invention can be practiced.

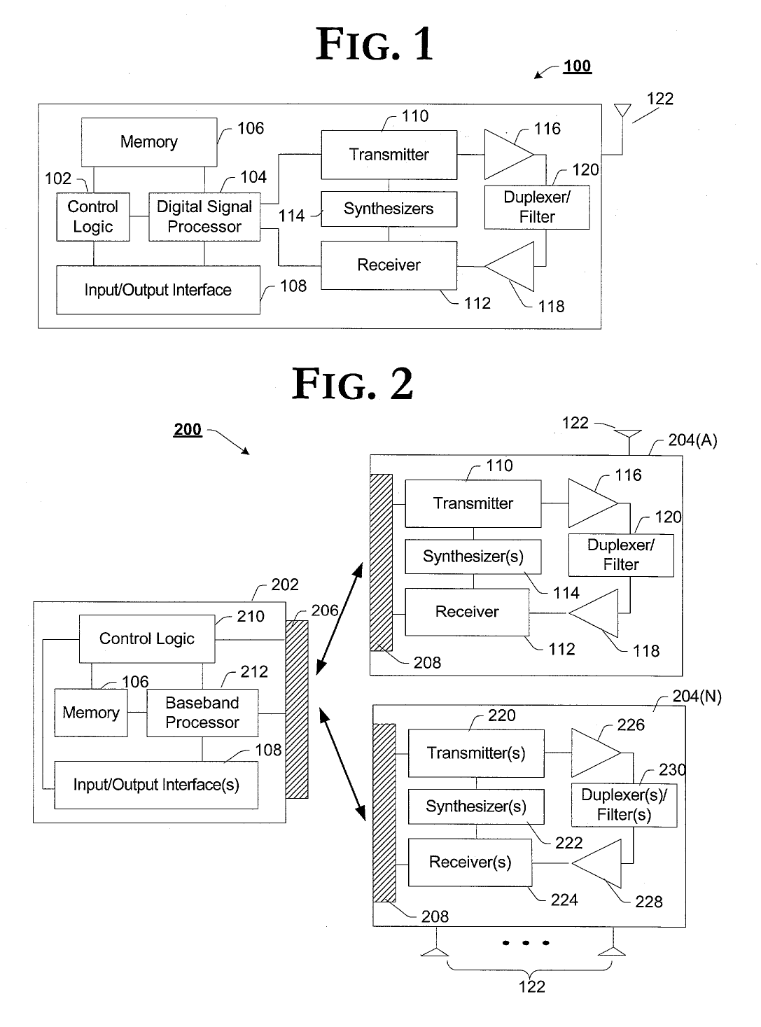

### DETAILED DESCRIPTION

Embodiments of the present invention are directed to a modular communications device and associated methods. In this regard, a modular communication device (MCD) is disclosed comprising a processing module that is removably coupled with a radio frequency interface module (RIM). As disclosed herein, the processing module performs one or more of baseband processing, filtering, compression/decompression and/or encryption/decryption of the payload in accordance with one or more multiple access techniques (e.g., FDMA, TDMA, CDMA, etc.). The removable radio frequency interface module (RIM) provides one or more of upconversion and downconversion to/from an operating spectrum of the RIM, filtering elements, amplification features, and one or more antenna elements. A given RIM is designed to enable the processing module to function in a particular wireless communication spectrum. A user may well purchase, rent, lease, etc. any of a number of alternate RIMs which, when coupled with a processing module, enables a user to migrate the processing module between multiple radio frequency environments.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

### EXAMPLE MODULAR COMMUNICATIONS DEVICE

FIG. 2 is a block diagram of an example modular communications device incorporating one embodiment of the teachings of the present invention, in accordance with one example implementation of the present invention. In accordance with the illustrated example implementation of FIG. 2, the modular communications device 200 is depicted comprising a processing module 202 and a number (N) of radio frequency interface modules (RIM) 204A . . . N. In accordance with one example implementation, the processing module 202 includes a coupling mechanism 206 that may be received by a complementary coupling mechanism 208 on the RIM 204A . . . N. Those skilled in the art will appreciate that any of a number of conventional and/or proprietary coupling mechanisms may well be used to enable the modular aspects of the present invention.

Processing module 202 is depicted comprising control logic 210, baseband processor 212, memory 106 and input/output interface(s) 108, each coupled as shown. In certain embodiments of the present invention, control logic 210 and baseband processor 212 may well represent conventional transceiver control logic 102 and DSP 104 without deviating from the spirit and scope of the present invention. In the illustrated example implementation, however, one or more of control logic 210 and/or baseband processor 212 may well be endowed with additional management feature(s), which improve the ease of use for the end-user vis-à-vis the modular functionality of the communications device 200. As will be discussed more fully below, control logic 210 may well identify whether a RIM is coupled to the processing module; determine whether a coupled RIM is suitable for the current wireless operating environment; selectively engage/disengage power to the RIM, and the like.

In accordance with the illustrated example embodiment, baseband processor 212 of processing module 202 performs baseband processing of the communications module 200. According to one example implementation, baseband processor 212 is endowed with content to enable it to operate in any number of multiple access wireless environments, e.g., FDMA, TDMA, CDMA, SDMA, and the like. Moreover, baseband processor 212 may well be extensible to operate in accordance with a newly developed multiple access wireless environment. According to alternate implementations, baseband processor 212 is intended to represent a number of signal processors, each dedicated to one or more of the multiple access wireless environments supported by the modular communications device 200.

Memory 106 and I/O interface(s) 108 are each intended to represent such devices and interfaces as they are commonly known in the art. In this regard, memory 106 is intended to represent volatile and/or non-volatile memory system wherein data and/or executable content is stored for use by processing module 202. I/O interface(s) 108 are intended to represent one or more of data interface(s) to other computing device(s) (e.g., PCMCIA, RS232, Universal Serial Bus (USB), etc.), an interface to media input/output device(s) (e.g., microphone, speaker, display, etc.), man-machine interface(s) (e.g., keypad) and the like.

The radio frequency interface module (RIM) may employ many different architectures in many different forms, depending on the wireless communications environment for which the RIM is designed. Thus, alternate implementations of the RIM 204A . . . N are illustrated in FIG. 2. In general, a RIM 204 will include one or more of a transmitter 110, a receiver 112, synthesizers 114, amplifiers 116 and 118, duplexers/filters 120, and an antenna 122, each coupled as shown with reference to RIM 204A. The transmitter(s), synthesizers, receivers, and duplexer/filters employed are based, at least in part, on the wireless spectrum in which the RIM is designed to operate. Although depicted comprising a transmitter and/or a receiver, those skilled in the art will appreciate that a mere upconverter and/or downconverter may well be used in place of a transmitter/receiver (respectively) if the RIM is merely converting between a carrier frequency and an intermediate frequency (IF). Such an alternate implementation may serve to further reduce the cost of the individual RIMs.

As used herein, transmitter 110 receives content from processing module 202 through the coupling mechanism 206 and 208 and upconverts the content to an appropriate frequency spectrum supported by synthesizers 114. The upconverted content is amplified by amplifier 116, filtered by filter 120 and transmitted via antenna 122. Conversely, content received via antenna element 122 is filtered by filter 120, amplified by amplifier 118 and downconverted in receiver 112 to a frequency (e.g., intermediate frequency (IF) or baseband) supported by processing module 202, and passed to processing module 202 through the coupling mechanism 208 and 206.

Another example implementation of a RIM 204 is presented with reference to RIM 204(N), wherein the RIM 204(N) may well comprise multiple transmitters 220, synthesizers 222, receivers 224, duplexer(s)/filter(s), and antenna elements 122, each coupled as shown. Those skilled in the art will appreciate that such multiple transmit and receive paths, coupled with an antenna array 122 may well be employed by an appropriately configured processor (e.g., baseband processor 212) to implement spatial division multiple access (SDMA) channels within the communication system. As introduced above, and illustrated in FIG. 2, RIM 204 will not typically be endowed with control logic and/or memory elements, as all of the processing and control features are enabled within the processing module 202 of the modular communications device 200. Those skilled in the art will appreciate that keeping the control logic and memory requirements of RIM 204 to a minimum will keep the cost of the RIM down to a point where a user might be encouraged to purchase multiple RIMs for use across a number of wireless communication environments.

### EXAMPLE IMPLEMENTATION AND OPERATION

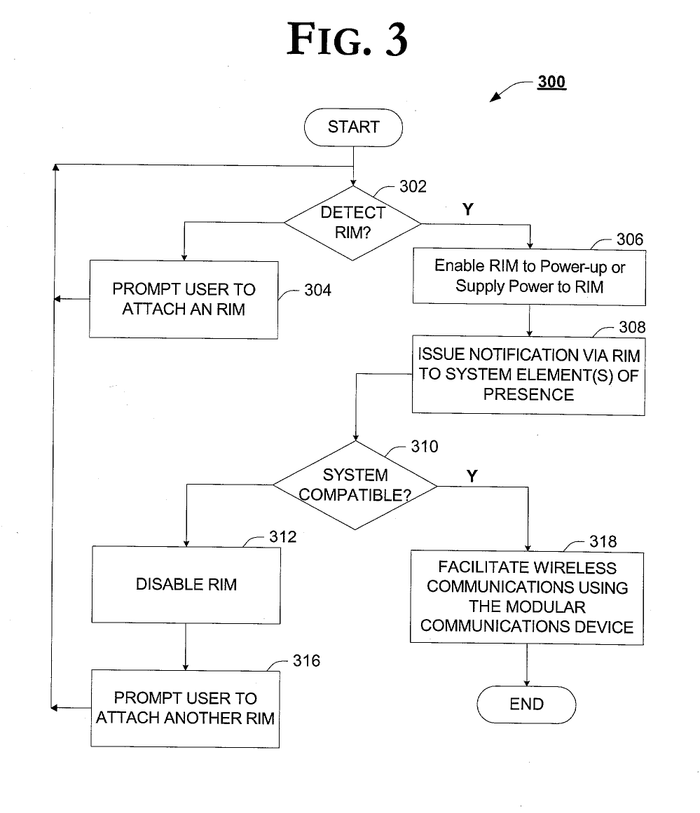

FIG. 3 is a flow chart of an example method of operation of an modular communications device, in accordance with one example embodiment of the teachings of the present invention. In accordance with the illustrated example implementation of FIG. 3, the process begins with block 302 wherein processing module 202 detects whether a radio frequency interface module (RIM) 204 is coupled with the processing module. In accordance with one example implementation, control logic 202 detects the presence of a RIM 204. More specifically, in accordance with one example implementation, coupling mechanism 206 includes a line with a pull-up resistor that, when coupled to the RIM is pulled to ground. Control logic 210 monitors the state of such line in determining whether a RIM 204 is properly coupled to the processing module 202. In alternate implementations, control logic 210 may well employ alternate hardware/software handshaking to detect the presence of a RIM 204.

If the processing module 202 fails to detect a RIM 204, it provides an indication to the user to attach a RIM 204 before the communications device 200 can be used, block 304. According to one example implementation, control logic 210 issues one or more of an audio and/or visual prompt to the user through, e.g., a speaker and/or display device of input/output interface(s) 108, and the process returns to block 302.

If processing module 202 does detect the presence of a RIM 204, processing module 202 enables use of the RIM 204. According to one example embodiment, processing module 202 supplies power to the detected RIM 204, block 306. According to another example embodiment, processing module 202 enables the RIM 204 to power-up, e.g., from a source of power external to processing module 202. According to one example implementation, application of power to the RIM 204 is managed by control logic 210. Once the presence of the RIM 204 is detected, control logic 210 enables power to the RIM 204.

In block 308, the modular communications device 200 issues a notification to the wireless communications system notifying the system of the presence of the device 200. More particularly, in accordance with one example implementation, control logic 210 prepares a control message, which is passed through DSP 212 to the transmit path of the RIM 204 for broadcast to the system, notifying the system of the presence of the MCD 200.

In block 310, processing module 202 determines whether the MCD 200 configuration of the processing module 202 and the coupled RIM 204 is compatible with the wireless environment of the communication system. According to one example implementation, control logic 210 of processing module 202 awaits a reply to the issued control message. If no reply is received within a given period of time, control logic 210 determines that the currently coupled RIM 204 is not compatible with the wireless environment of the communication system. Alternatively, control logic 210 may well receive a reply from the communication system wherein it is explicit within the reply that the currently coupled RIM 204 is not compatible with the wireless environment of the communication system.

Upon determining that the currently coupled RIM 204 is not compatible with the communication system in block 310, processing module 202 disables power to the currently coupled RIM 204, block 312. In accordance with the illustrated example implementation introduced above, control logic 210 disables the RIM 204, and provides an indication (audible and/or visual) to that the currently coupled RIM is not compatible with the system, and to attach another RIM, block 316, as the process returns to block 302.

If, in block 310, control logic 210 determines that the currently coupled RIM 204 is compatible with the wireless environment of the communication system, the modular communications device facilitates wireless communications between the MCD 200 and the host wireless communication system until tear-down or some other interruption of the communication session, block 316.

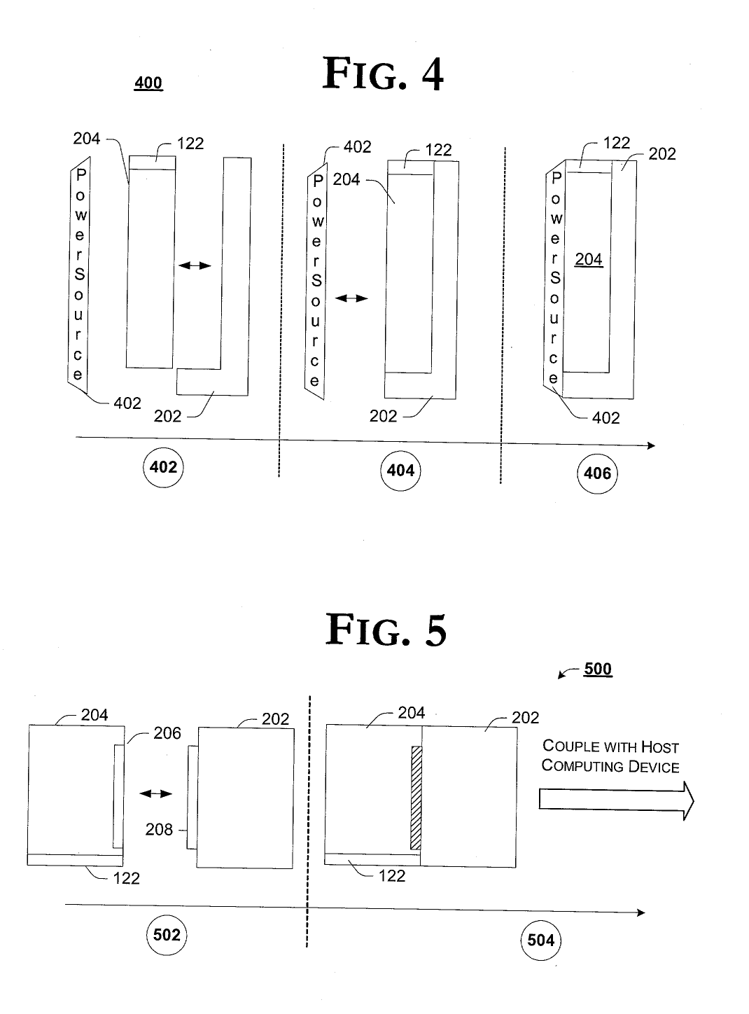

FIG. 4 is a graphical illustration of an example modular communications device, in accordance with but one example implementation of one embodiment of the teachings of the present invention. In accordance with the illustrated example embodiment of FIG. 4, a modular communications device 400 in accordance with a portable wireless telephony subscriber unit paradigm is presented. More particularly, an example modular communications device 400 and associated assembly process is presented in accordance with reference to FIG. 4.

As shown, the modular wireless telephony subscriber unit 400 is generally comprised of a processing module 202, a RIM 204 with antenna element(s) 122, and, optionally, a power source, state 402. In state 404, a user couples the RIM 204 with the processing module 202, as described above. In state 406, a user couples the power source 402 to the processing module 202 and/or the RIM 204. As introduced above, in accordance with one example implementation, although the power source 402 may well be coupled to one or more of the processing module 202 and the RIM 204, power control to the RIM 204 is managed by processing module 202. Moreover, power to the RIM 204 may well be provided by processing module 202 and, in this regard, there would not be an electrical connection between the RIM 204 and the power source 402. Those of ordinary skill in the art will appreciate, given the discussion above, that the teachings of the present invention are primarily directed to the modular communications device, and not to the source of power supporting such device.

FIG. 5 is a graphical illustration of an example modular communications device, in accordance with another example implementation of but one embodiment of the teachings of the present invention. More particularly, FIG. 5 is intended to represent a wireless access point 500 embodiment of the modular communications device 200, and an associated process for assembling the device for use with an electronic device. In accordance with the illustrated example implementation, the host electronic device (not specifically shown) will provide power to the modular wireless access point and, in this regard, no additional power source (e.g., 402) is depicted.

With reference to FIG. 5, a modular wireless modem 500 comprising a processing module 202 and a removable RIM 204 is presented in a disassembled state 502. In state 504, a user joins the processing module 202 to the RIM 204 to create a fully functional wireless modem. When the modem is coupled with a host computing device, data from the host device can be transmitted to a wireless network via the wireless modem.

Although illustrated in accordance with a modular wireless access point embodiment in FIG. 5, those skilled in the art will appreciate that a wireless access basestation may also benefit from the teachings of the present invention. That is, a modular wireless access basestation is anticipated comprising a processing module 202 with an integrated power source (e.g., a power supply with integrated power cord) and a removable radio frequency interface module (RIM) 204 without deviating from the scope and spirit of the present invention.

### EXAMPLE OPERATING ENVIRONMENT(S)

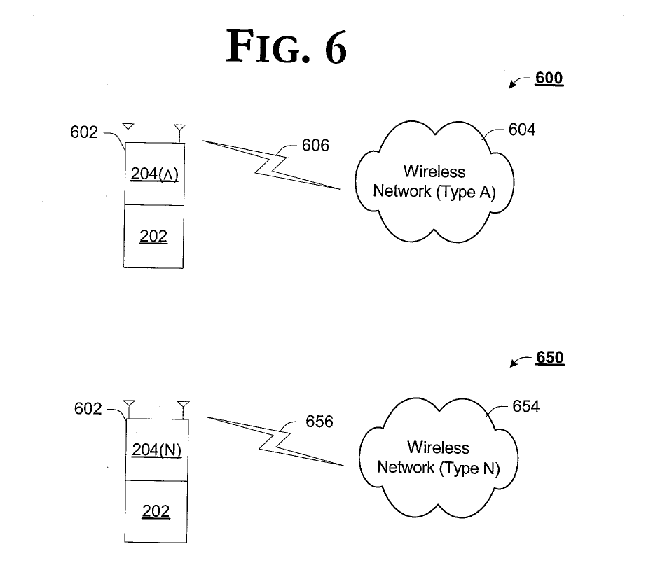

FIG. 6 presents a block diagram illustrating a modular communications device incorporating one embodiment of the teachings of the present invention deployed within alternate communication systems by replacing a removably coupled radio frequency module. More particularly, FIG. 6 depicts a modular communications device 602 modified to function in two alternate wireless environments of wireless network type (A) 604, and wireless network type (N) 654. More specifically, FIG. 6 illustrates that by coupling an appropriate RIM 204 to a processing module 202, a flexible modular communications device 602 is created which may be adapted to work in multiple wireless communication environments.

With reference to wireless communication system 600, modular communications device 602 is presented in communication with wireless network 604 via one or more wireless communication channels 606. In accordance with one embodiment of the teachings of the present invention, modular communications device 602 is removably endowed with RIM 204(A), which is appropriate for the type of wireless environment supported by wireless network 604.

When a user of modular communications device 602 moves to communication system 650, a different RIM 204 is required. That is, communication system 650 is comprised of wireless network type (N). In order to function within this wireless environment, a user is required to attach an RIM that is compatible with the wireless network type (N) 654, i.e., RIM 204(N). Once endowed with a suitable RIM 204(N), modular communications device 602 may well establish one or more communication channels 656 with wireless network 654.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps. The steps of the present invention may be performed by hardware components, such as those shown in FIG. 2, or may be embodied in machine-executable instructions, which may be used to cause a general-purpose or special-purpose processor or logic circuits programmed with the instructions to perform the steps. Alternatively, the steps may be performed by a combination of hardware and software. The steps have been described as being performed by either the base station or the user terminal. However, any steps described as being performed by the base station may be performed by the user terminal and vice versa. The invention is equally applicable to transceivers and/or systems in which terminals communicate with each other without either one being designated as a base station, a user terminal, a remote terminal or a subscriber station. The invention can further be applied to a network of peers.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while the present invention has been described in the context of a wireless communication system for portable devices, it can be applied to a wide variety of different wireless systems in which data are exchanged. Such systems include voice, video, music, broadcast and other types of systems without external connections. The present invention can be applied to fixed remote terminals as well as to low and high mobility terminals. Many of the methods are described in their most basic form but steps can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the present invention is not to be determined by the specific examples provided above but only by the claims below.

What is claimed is:

1. A wireless communications device comprising:
a processing module; and
a radio frequency interface module (RIM), removably coupled to the processing module, to merely convert signals between a wireless communications environment and the processing module.

2. A wireless communications device according to claim 1, the processing module comprising:
a baseband processor, coupled with the RIM, to process content at baseband in accordance with any of a number of wireless communication access technologies.

3. A wireless communications device according to claim 2, wherein the baseband processor converts content between baseband and an intermediate frequency (IF) supported by the RIM.

4. A wireless communications device according to claim 1, the processing module comprising:
control logic, to detect whether a RIM is coupled to the processing module.

5. A wireless communications device according to claim 4, wherein the control logic manages an operational state of a detected RIM.

6. A wireless communications device according to claim 4, wherein the control logic constructs a control message which is transmitted through the RIM to a basestation in the wireless communications environment to determine whether the RIM is compatible with the wireless communications environment.

7. A wireless communications device according to claim 4, wherein the control logic disables the RIM if it is determined to be incompatible with the host communication system.

8. A wireless communications device according to claim 4, wherein the control logic facilitates subsequent communications if it receives an indication that the RIM is compatible with the host communication system.

9. A wireless communications device according to claim 8, wherein the indication that the RIM is compatible with the host communication system is a recognized response to the issued control message.

10. A wireless communications device according to claim 1, the RIM comprising:
an upconverter element, to receive content from the processing module and upconvert the content to a frequency recognized by a particular wireless communications environment;
an amplifier, coupled to the upconverter element, to amplify the upconverted content for transmission via a coupled one or more antenna(e).

11. A wireless communications device according to claim 10, wherein the upconverter is an element of a transmitter.

12. A wireless communications device according to claim 1, the RIM comprising:
an amplifier, to increase an amplitude component of content received from the wireless communications environment via one or more coupled antenna(e); and
a downconverter element, responsive to the amplifier, to downconvert the amplified received content from a frequency within a spectrum utilized by the wireless communications environment to a format employed by the processing module.

13. A wireless communications device according to claim 12, wherein the downconverter is an element of a receiver.

14. A method facilitating wireless communications using a modular communications device, the method comprising:
receiving an indication to engage a modular communications device, the indication received by a processing module of the modular communications device; and
determining whether the modular communications device is endowed with a removably coupled radio frequency interface module (RIM).

15. A method according to claim 14, wherein the received indication is one or more of a power-on indication, a reset indication, or another indication that a user of the device is ready to begin communications using the modular communication device.

16. A method according to claim 15, wherein determining comprises:
monitoring a status line of a mechanism used to couple the processing module to the RIM to detect when the RIM has been removably coupled to the processing module.

17. A method according to claim 15, wherein determining comprises:
employing hardware and/or software handshaking between the processing module and the RIM to determine when a RIM is removably coupled to the processing module.

18. A method according to claim 15, further comprising:
providing a user of the modular communications device with an indication to attach a different RIM if the processing module fails to detect the current RIM.

19. A method according to claim 14, further comprising:
determining whether a removably coupled RIM is compatible with a wireless environment of a host wireless communication system.

20. A method according to claim 19, wherein determining whether the RIM is compatible with the wireless environment comprises:
issuing a generated control message to the host wireless communication system, wherein a recognized reply to the control message denotes that the RIM is compatible with the host wireless communication system.

21. A method according to claim 20, wherein the control message is generated within the processing module and transmitted via the RIM to the host wireless communication system.

22. A method according to claim 20, wherein a response to the control message is received via the RIM and processed by the processing module to verify that the RIM is compatible with the host wireless communication system.

23. A method according to claim 19, further comprising:
disabling the RIM identified as incompatible with the host wireless communication system; and
issuing a notification to a user of the modular communications device that the currently coupled RIM is not compatible with the host wireless communication system.

25. A method according to claim 20, further comprising:
prompting a user of the modular communications device to try another RIM if the RIM is determined to be incompatible with the host wireless communication system.

26. A storage medium comprising executable content which, when executed by an accessing electronic device, causes the device to implement a method according to claim 14.
